(19) United States
(12) Patent Application Publication
(10) Pub. No.: US 2026/0217002 A1
(43) Pub. Date: Jul. 30, 2026

(54) MULTILAYER FILM AND FLEXIBLE SINGLE-MATERIAL POUCH

(71) Applicant: GUALA PACK S.P.A., Castellazzo Bormida (Alessandria) (IT)

(72) Inventor: Riccardo ZAMMORI, Castellazzo Bormida (Alessandria) (IT)

(21) Appl. No.: 19/142,549

(22) PCT Filed: Jan. 12, 2024
(86) PCT No.: PCT/IB2024/050332

§ 371 Date: Jun. 23, 2025

(30) Foreign Application Priority Data
Jan. 13, 2023 (IT) 102023000000420

(51) Int. Cl. B32B 27/08; B32B 27/30; B32B 27/32; B65D 75/26

(52) U.S. Cl. CPC B32B 27/08; B32B 27/302; B32B 27/32; B65D 75/26; B32B 2250/242; B32B 2255/20; B32B 2307/31; B32B 2307/516; B32B 2307/518; B32B 2307/546; B32B 2307/7242; B32B 2439/46

(57) ABSTRACT

A flexible, single-material pouch, sealed for containment of a liquid or solid product, has a front wall and a rear wall welded together, and a left lead-in and a right lead-in joined by an imaginary tear line. The front wall and the rear wall are constituted of a flexible multilayer film constituted of an inner sealing layer and an outer layer made of mono-oriented polypropylene (MDOPP) parallel to the imaginary tear line.

The present invention is in the area of multilayer films; in particular, the subject matter of the present invention is a multilayer film used in the packaging sector for making a flexible single-material pouch with ease of opening.

For a number of years now, the research and development efforts of manufacturing companies operating in the film industry have been directed toward the production of single-material, multilayer films which make it possible to produce flexible pouches that, once used, are easy to dispose of and are particularly sustainable, insofar as they are made of a single material.

The Applicant, for example, has for a number of years been producing and marketing a pouch called Pouch5®, made from a flexible, multilayer, single-material film made of polypropylene (PP), which is particularly suitable for hot-filling and pasteurized applications or fresh produce and dairy products.

A further multilayer film is shown, for example, in the document WO-A1-2021/154175.

The Applicant has, however, found that those multilayer films known today do not provide a satisfactory result when used for making tear-open pouches.

The object of the present invention is to manufacture a single-material, multilayer film that is particularly suitable for making a flexible pouch with a rip or tear opening, and a pouch obtained from said multilayer film.

This object is achieved by a flexible, multilayer film according to claim 1 and a flexible, single-material pouch according to claim 8. The features and advantages of the multilayer film and of the flexible pouch according to the present invention will be apparent from the description provided hereinafter, given by way of non-limiting, according to the figures in the accompanying drawings, wherein:

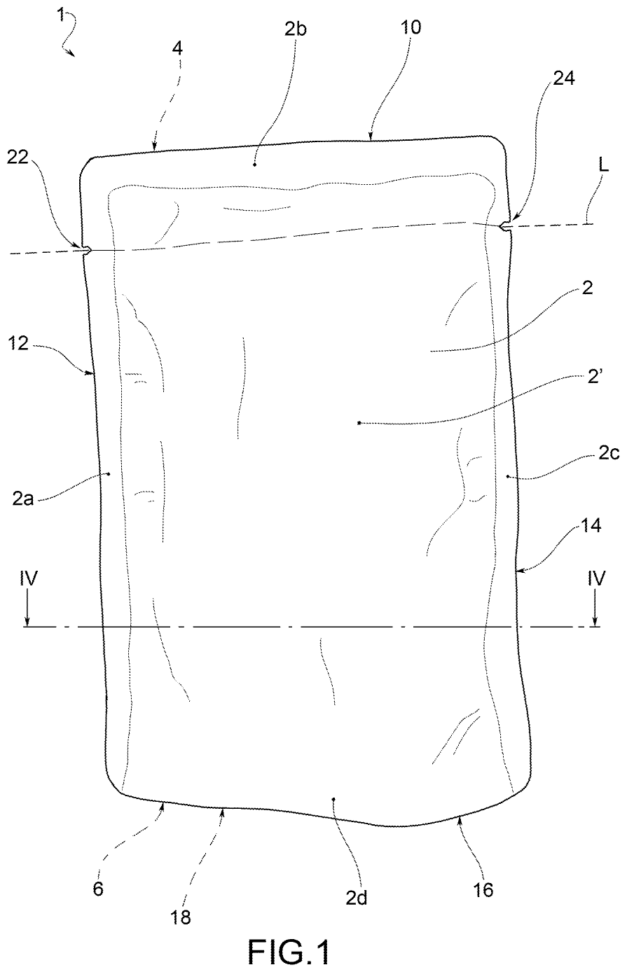

FIG. 1 shows an example of a flexible, single-material pouch;

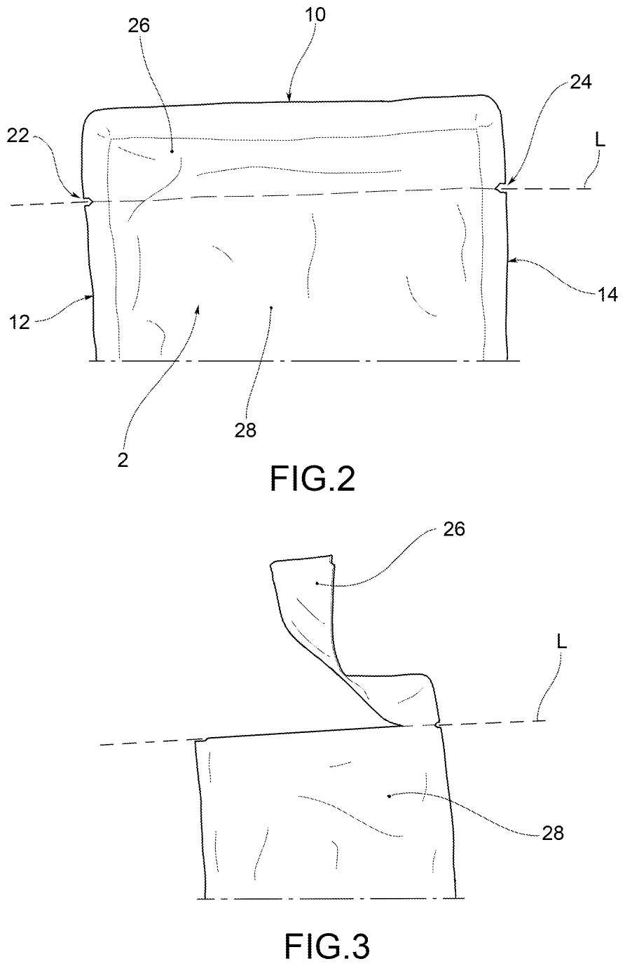

FIG. 2 depicts a portion of the pouch in FIG. 1;

FIG. 3 shows the pouch in a torn-open configuration;

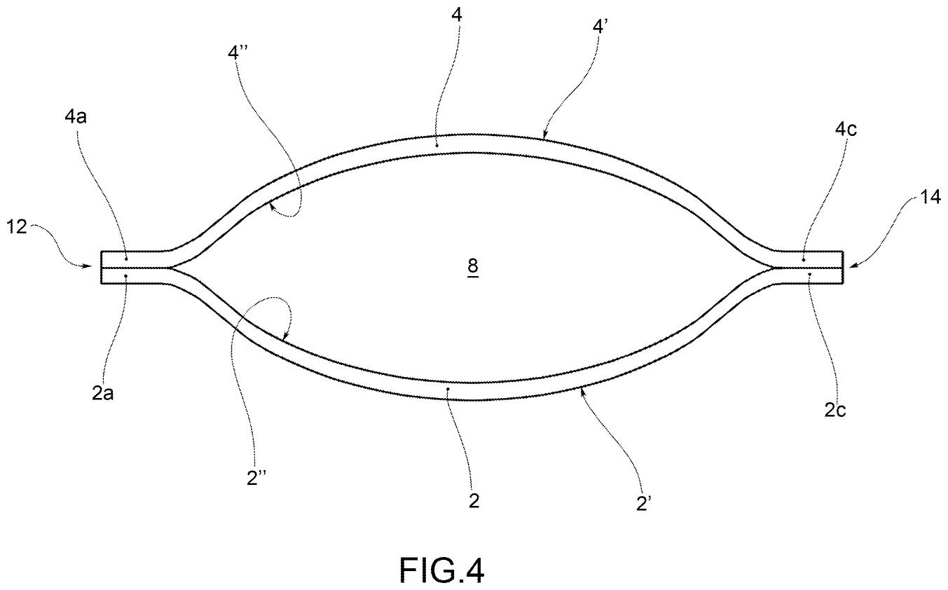

FIG. 4 is a schematic cross-section of the pouch of FIG. 1, according to the sectional plane IV-IV of FIG. 1;

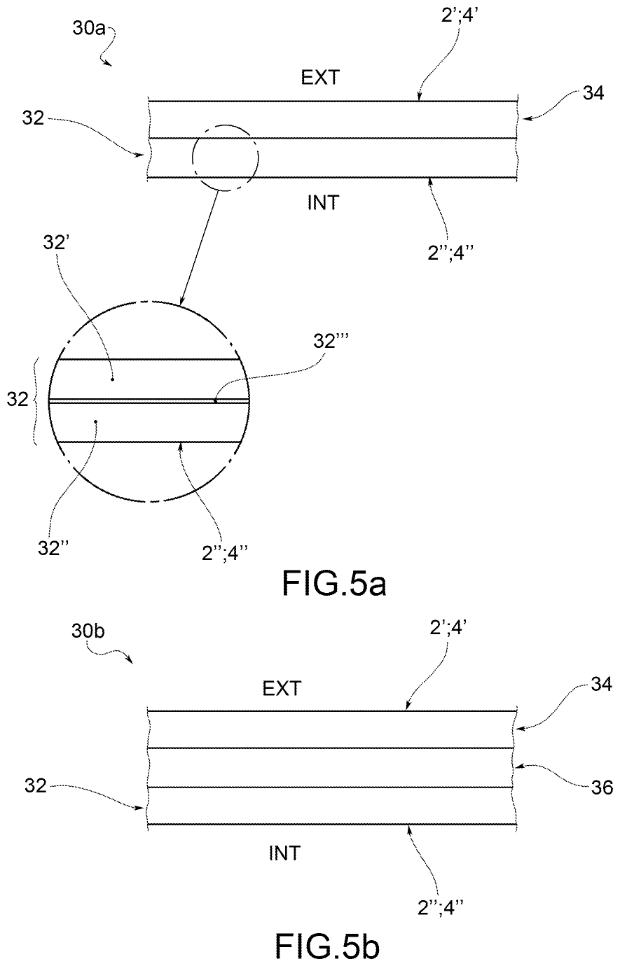

FIGS. 5a and 5b each show a diagram of a multilayer film according to one embodiment of the present invention.

With reference to the figures of the accompanying drawings, the reference numeral 1 denotes a flexible pouch with a tear opening.

The pouch 1 comprises a flat front wall 2, having an outer face 2′ and an inner face 2″, delimited peripherally by a left side 2a, an upper side 2b, a right side 2c and a lower side 2d, all preferably straight.

The pouch 1 further comprises a flat rear wall 4, having an outer face 4′ and an inner face 4″, delimited peripherally by a left side 4a, an upper side 4b, a right side 4c and a lower side 4d, all preferably straight.

According to one embodiment variant, the pouch 1 further comprises a base wall 6 arranged between the front wall 2 and the rear part 2, at a lower end of the pouch 1. The base wall 6 has an outer face and an inner face and is delimited peripherally by base sides, wherebetween there is a front side and a rear side.

The front wall 2 and the rear wall 4 are facing and coupled along said sides 2a, 2b, 2c, 2d, 4a, 4b, 4c, 4d in such a way as to form the pouch 1, internally provided with a sealed closed compartment 8 for containing a product; the pouch is delimited by an upper edge 10, a left edge 12, a right edge 14 and a lower edge.

Along the upper edge 10 of the pouch 1, the upper side 2b of the front wall 2 and the upper side 4b of the rear wall 4 are welded; along the left edge 12 of the pouch 1, the left side 2a of the front wall 2 and the left side 4a of the rear wall 4 are welded; along the right side 14 of the pouch 1, the right side 2c of the front wall 2 and the right side 4c of the rear wall 4 are welded; along the lower edge of the pouch 1, the lower side 2d of the front wall 2 and the lower side 4d of the rear wall are welded.

In the embodiment variant shown, wherein the base wall 6 is also envisaged, the pouch 1 has, in place of a single lower edge, a front lower edge 16 and a rear lower edge 18: along the front lower edge 16 of the pouch 1, the lower side 2d of the front wall 2 and the front side of the base wall 6 are welded; along the rear lower edge 18 of the pouch 1, the lower side 4d of the rear wall 4 and the rear side of the base wall 6 are welded.

According to the invention, in proximity to the upper edge 10, the pouch 1 provides for a left lead-in 22 obtained along the left edge 12 and a right lead-in 24 obtained along the right edge 14. Said lead-ins 22, 24 are preferably comprised of notches passing through the thickness of the front wall 2 and of the rear wall 4.

The left lead-in 22 and the right lead-in 24 are joined by an imaginary, straight tear line L, preferably parallel to the upper edge 10, which, in an imaginary sense, divides the pouch 1 into an upper portion 26 and a lower portion 28.

To open the pouch 1 and allow the product to flow out of the compartment 8, the pouch 1 is torn along the tear line L (FIG. 3).

For example, when the lower portion 28 of the pouch 1 is grasped with the left hand, for example holding, between the thumb and forefinger, a section of the left edge 12 below the left lead-in 22, and with the right hand the upper portion 26 of the pouch 1, for example holding, between the thumb and forefinger, a section of the left edge 12 above the left lead-in 22, it is possible to tear the pouch 1 along the tear line L.

According to the invention, the front wall 2 and the rear wall 4, and preferably also the base wall 6, are comprised of a laminated, multilayer film 30a, 30b which provides for a structure consisting of a plurality of overlapping layers.

According to a first embodiment (FIG. 5a), the multilayer film 30a is comprised of an inner sealing layer 32 that bears for example the inner face 2″ of the front wall 2 or else the inner face 4″ of the rear wall 4, and an outer layer 34, that bears for example the outer face 2′ of the front wall 2 or else the outer face 4′ of the rear wall 4.

The sealing layer 32 comprises a sealing surface sub-layer 32″ made of polypropylene (PP).

For example, the sealing layer 32 is a co-extruded layer comprised of the sealing surface sub-layer 32″ made of polypropylene (PP), an inner sub-layer 32′ made of polypropylene (PP) and an intermediate sub-layer 32′″, arranged between the surface sub-layer 32″ and the inner sub-layer 32′, having gas barrier properties, for example made of Ethylene-Vinyl-Alcohol (EVOH).

For example, the sealing layer has a thickness of between 20 and 120 microns, for example, the intermediate sub-layer has a thickness of between 3 and 30 microns.

The outer layer 34 is made of mono-oriented polypropylene (MDOPP), wherein the preferential orientation direction of the material is aligned substantially parallel to the tear line L and parallel to an unwinding direction of a reel of said film.

In the present description, the term “mono-oriented” refers to a layer that has undergone a stretching process in one direction only (mono-orientation). In other words, the mono-orientated layer has polymeric chains oriented predominantly along a preferable direction. The mono-orientation is applied to the layer in a longitudinal direction, i.e., in a direction of greatest extension of the layer, which corresponds to an unwinding direction of a reel of film.

According to a further embodiment (FIG. 5b), the multilayer film 30b is comprised of an inner sealing layer 32 that bears for example the inner face 2″ of the front wall 2 or else the inner face 4″ of the rear wall 4, and an outer layer 34, that bears, for example, the outer face 2′ of the front wall 2 or else the outer face 4′ of the rear wall 4 and an intermediate layer 36, arranged between the sealing layer 32 and the outer layer 34, having gas barrier properties.

The sealing layer 32 is made of polypropylene (PP), the outer layer 34 is made of mono-oriented polypropylene (MDOPP), wherein the preferential orientation direction of the material is aligned substantially parallel to the tear line L of the pouch and parallel to an unwinding direction of a reel of said film.

In a variant of such embodiment, the intermediate layer 36 is made of bi-oriented polypropylene (BOPP, or sometimes simply OPP) provided internally and/or externally with an inorganic coating (SiOx or AlOx).

In a further variant of such embodiment, the intermediate layer 36 is a co-extruded layer comprised of an inner sub-layer 36″ made of polypropylene (PP), an outer sub-layer 36′ made of polypropylene (PP) and an intermediate sub-layer 36′″, arranged between the inner sub-layer 36″ and the outer sub-layer 36′, having gas barrier properties, for example made of Ethylene-Vinyl-Alcohol (EVOH).

For example, the inner layer has a thickness of between 10 microns and 100 microns, preferably of between 40 and 70 microns.

For example, the intermediate layer has a thickness of between 10 and 30 microns, preferably of between 15 and 20 microns.

For example, the outer layer has a thickness of between 15 and 80 microns, preferably of between 20 and 60 microns, preferably of between 30 and 50 microns.

For example, some examples of multilayer films are: MDOPP30-PP/EVOH/PP90, MDOPP30-OPPbarriera20-PP60, MDOPP30-OPPbarriera18-PP50, MDOPP30-OPPbarriera25-PP50, MDOPP20-OPPbarriera20-PP60.

The pouch is a single-material insofar as it is comprised of the same material, i.e., polypropylene, albeit in different forms.

In other words, according to the invention, the multilayer film provides that the degree of orientation in the longitudinal direction (i.e., parallel to the unwinding direction of the reel) of the polymer structure of each layer along the tear line increases from the inside to the outside of the pouch; consequently the melting temperature, and thus the sealing temperature, decreases from the outside to the inside.

Advantageously, this allows the walls of the pouch to be optimally welded, insofar as the inner layer of each wall, which together with the opposite wall forms the seal, has a lower melting temperature than the outer layer, which, on the other hand, remains essentially unchanged at the welding temperature of the inner layer, thus avoiding any sticking to the welding head.

It is clear that those skilled in the art may make changes to the multilayer film and to the flexible pouch described above in order to meet incidental needs, which changes all fall within the scope of protection defined in the following claims.

What is claimed is:

1-10. (canceled)

11. A flexible, single-material pouch, sealed for containment of a liquid or solid product, the flexible, single-material pouch comprising a front wall having a left side, an upper side and a right side, and a rear wall having a left side, an upper side and a right side, wherein
the left side of the front wall is welded to the left side of the rear wall to form a left edge of the flexible, single-material pouch, the upper side of the front wall is welded to the upper side of the rear wall to form an upper edge of the flexible, single-material pouch, and the right side of the front wall is welded to the right side of the rear wall to form a right edge of the flexible, single-material pouch;
the flexible, single-material pouch further comprises a left lead-in along the left edge, near the upper edge and a right lead-in along the right edge, near the upper edge, the left and right lead-ins being joined by an imaginary tear line; and
the front wall and the rear wall are constituted of a laminated flexible multilayer film constituted of an inner sealing layer and an outer layer, wherein the inner sealing layer faces an inside of the flexible, single-material pouch and comprises a sealing surface sub-layer made of polypropylene (PP), and wherein the outer layer is made of mono-oriented polypropylene (MDOPP) parallel to the imaginary tear line.

12. The flexible, single-material pouch of claim 11, wherein the left and right lead-ins are notches.

13. The flexible, single-material pouch of claim 11, wherein the inner sealing layer is a co-extruded layer constituted of the sealing surface sub-layer, an inner sub-layer made of polypropylene (PP), and an intermediate sub-layer arranged between the sealing surface sub-layer and the inner sub-layer, and having gas barrier properties.

14. The flexible, single-material pouch of claim 13, wherein the intermediate sub-layer is made of ethylene-vinyl-alcohol (EVOH).

15. A reel comprising a reel body and a laminated flexible multilayer film wound around the reel body, wherein the laminated flexible multilayer film is constituted of an inner sealing layer and an outer layer, wherein the inner sealing layer comprises a sealing surface sub-layer made of polypropylene (PP), wherein the laminated flexible multilayer film is unwound from the reel body along an unwinding direction, and wherein the outer layer is made of mono-oriented polypropylene (MDOPP) parallel to the unwinding direction.

16. A flexible, single-material pouch, sealed for containment of a liquid or solid product, the flexible, single-material pouch comprising a front wall having a left side, an upper side and a right side, and a rear wall having a left side, an upper side and a right side, wherein
the left side of the front wall is welded to the left side of the rear wall to form a left edge of the flexible, single-material pouch, the upper side of the front wall is welded to the upper side of the rear wall to form an upper edge of the flexible, single-material pouch, and the right side of the front wall is welded to the right side of the rear wall to form a right edge of the flexible, single-material pouch;
the flexible, single-material pouch further comprises a left lead-in along the left edge, near the upper edge and a right lead-in along the right edge, near the upper edge, the left and right lead-ins being joined by an imaginary tear line; and
the front wall and the rear wall are made of a laminated flexible multilayer film constituted of an inner sealing layer, an outer layer, and an intermediate layer arranged between the inner sealing layer and the outer layer and having gas barrier properties, wherein the inner sealing layer faces an inside of the flexible, single-material pouch and is made of polypropylene (PP), and wherein the outer layer is made of mono-oriented polypropylene (MDOPP) parallel to the imaginary tear line.

17. The flexible, single-material pouch of claim 16, wherein the intermediate layer is made of bi-oriented polypropylene (BOPP) provided internally and/or externally with an inorganic coating, the inorganic coating being a silicone oxide (SiOx) coating or an aluminum oxide (AlOx) coating.

18. The flexible, single-material pouch of claim 17, wherein the intermediate layer is a co-extruded layer constituted of an inner sub-layer made of polypropylene (PP), an outer sub-layer made of polypropylene (PP), and an intermediate sub-layer arranged between the inner sub-layer and the outer sub-layer, and having gas barrier properties.

19. The flexible, single-material pouch of claim 18, wherein the outer sub-layer is made of ethylene-vinyl-alcohol (EVOH).

20. A reel comprising a reel body and a laminated flexible multilayer film wound around the reel body, wherein the laminated flexible multilayer film is constituted of an inner sealing layer, an outer layer, and an intermediate layer arranged between the inner sealing layer and the outer layer, wherein the inner sealing layer is made of polypropylene (PP) and the intermediate layer has gas barrier properties, wherein the laminated flexible multilayer film is unwound from the reel body along an unwinding direction, and wherein the outer layer is made of mono-oriented polypropylene (MDOPP) parallel to the unwinding direction.
